(19) United States
(12) Patent Application Publication
(10) Pub. No.: US 2025/0391905 A1
(43) Pub. Date: Dec. 25, 2025

(54) LAYOUT OF LEAD ACID BATTERY

(71) Applicant: FIAMM ENERGY TECHNOLOGY S.P.A., Montecchio Maggiore (VI) (IT)

(72) Inventors: DARIO DAL MASO, Montecchio Maggiore (VI) (IT); DARIO PELOSO, Montecchio Maggiore (VI) (IT); SILVIA CAZZANTI, Montecchio Maggiore (VI) (IT); SILVIO PANTALONI, Montecchio Maggiore (VI) (IT)

(73) Assignee: FIAMM ENERGY TECHNOLOGY S.P.A., Montecchio Maggiore (VI) (IT)

(21) Appl. No.: 18/878,402

(22) PCT Filed: Jun. 28, 2023
(86) PCT No.: PCT/EP2023/025297

§ 371 Date: Dec. 23, 2024

(30) Foreign Application Priority Data
Jul. 1, 2022 (IT) 102022000013990

(51) Int. Cl. H01M 10/04; H01M 4/14; H01M 10/12; H01M 50/114; H01M 50/486; H01M 50/536

(52) U.S. Cl. CPC H01M 10/0468; H01M 4/14; H01M 10/121; H01M 50/114; H01M 50/486; H01M 50/536

(57) ABSTRACT

A 12 V lead acid battery (100) with VRLA AGM technology. according to the 6×1 configuration and with front terminal connections, provides a monobloc consisting of—a container (10), with support base and retaining sides, of the known type—plate groups (12)—compression baskets (14) of the plate groups (12)—inter-plate connections or CoS (16)—relief valves (18)—inter-cell connections (20)—a lid (22) closing the container (10), also of the known type; said monobloc have an internal layout configured to house the plate groups (12) in a horizontal position, parallel to the lid (22).

### DESCRIPTION

The present invention relates to a lead acid battery.

More in particular, the present invention relates to the arrangement of plate groups inside the monobloc of a range of types of 12 V lead acid batteries of VRLA (Valve Regulated Lead Acid batteries) AGM (Absorbed Glass Mat) technology.

More in particular, the present invention relates to a layout of lead acid battery that allows the plates to be arranged horizontally in the cells inside the monobloc.

The needs of new, rapidly developing markets (“energy storage”, photovoltaics, etc.) have led to a significant and increased exploitation of the performance of traditional lead acid batteries, with an ever-increasing demand for storage systems with high discharge and charge capacities and increasingly onerous requirements. The interest aimed at energy saving has supported the development of the energy storage sector, further expanding its industrial application: the increased deep cycling requirements overlap, therefore, with the need to still maintain high performance at high discharge current rates.

As it is known, lead acid batteries are accumulators in which the electrodes are composed of lead dioxide (positive electrodes) and pure lead (negative electrodes) sheets (plates) and the electrolyte consists of sulfuric acid. A set of positive electrodes forms a set of positive plates, a set of negative electrodes forms a set of negative plates, a set of negative plates and a set of positive plates form a plate group and, in turn, a plate group forms the battery cell.

In a conventional free-acid battery, during the charge phase, dissociation of water into hydrogen and oxygen occurs: the two gases escape from the caps as the electrolyte level inside the battery decreases.

A battery with VRLA AGM technology, on the other hand, utilizes the principle of recombination. Thanks to a special microporous fiberglass separator, impregnated with a controlled amount of electrolyte, the oxygen, released from the positive plate as a result of water dissociation, can migrate to the negative plate during the charge phase, by which it is fixed and then recombines with hydrogen, restoring the previously dissociated water. A closed electrochemical cycle is thus established, in the beginning, with no gas emission to the outside and no water consumption. To prevent any overpressure, the individual battery cells are equipped with a relief valve that guarantees maximum safety even in the event of a malfunction.

This technology is ideal for applications that require maximum starting current, extreme resistance to charge and discharge cycles, no maintenance, and no liquid and gas leakage.

During charge and discharge cycles, however, the active masses are subject to high volume changes due to chemical transformations of the reagents. This phenomenon induces a detachment of active mass and a change in the inter-electrode distances, which, in the long run, leads to a deterioration of battery functionality.

In cycles with high depth of discharge, the most common events which lead to battery degradation and, consequently, loss of performance, are electrolyte stratification (inhomogeneity of electrolyte density in height and consequent non-uniform utilization of plate surface area) and the inability of the plate or positive electrode to fully recharge, so that it progressively loses capacity in subsequent cycling.

The electrodes (positive and negative) and their separator are conventionally arranged inside the cell in a vertical orientation, in compression with each other; however, this orientation, due to the effect of gravity, is commonly the cause of the difference in sulfuric acid concentration between the top and bottom of the separator. Purpose of this invention is to provide a range of types of 12 V lead acid batteries of VRLA AGM technology with an internal monobloc layout or arrangement suitable for reducing the harmful effects of stratification, mainly related to gravity.

More in particular, the purpose of the present invention is to provide an internal monobloc configuration with plate group housing in a horizontal position, such that, at the individual plate level, homogeneous electrolyte density and thus increased cyclic life is guaranteed.

Batteries with a horizontal plate orientation are already known.

Document EP2786438B1 discloses a lead acid battery case with an internal volume divided into six compartments, perpendicular to the lid of the case, each being used for the storage of an electrical cell with lead sheets oriented horizontally and parallel to the lateral retaining sides of the case.

Document CN204189856U discloses a battery in which the positive and negative plates are arranged horizontally and the plate groups are stacked in a vertical direction in a 1×6 arrangement.

In both the aforementioned documents, the arrangement of the plates inside the monobloc with a horizontal orientation is fundamentally parallel to the retaining sides of the case and, therefore, perpendicular to the battery lid.

Further purpose of the present invention is to provide a lead acid battery layout that, by varying only the height of the monobloc according to the number of plates required, can cover the wide range of types of existing 12 V battery.

Yet further purpose of the present invention is to strengthen and maintain more constant over time the degree of compression engineered for a given plate group, preventing loss of functionality when the battery is subjected to heavy cyclic operating life.

In this regard, batteries adopting plate group compression systems are already known.

Document U.S. Pat. No. 5,409,787A, for example, discloses a system for maintaining cell integrity within a battery by maintaining intimate plate-to-separator contact and substantially isolating them from the expansion of the container; such a compression system provides a tying group that uses, on one hand, the container lid as a rigid support plate and, in opposition, the plates themselves, sufficiently isolated from the rest of the battery compartment, tying them together through tensile elements.

Not the least still purpose of the present invention is to improve processability during battery production by facilitating the insertion of the plate group inside the monobloc and significantly reducing the possibility of scraps.

These and other purposes are achieved by the led acid battery object of the present invention in accordance with the main claim.

The constructional and functional characteristics of the lead acid battery of the present invention may be better understood from the following description, in which reference is made to the attached tables of drawings which represent a preferred and not limiting embodiment and in which:

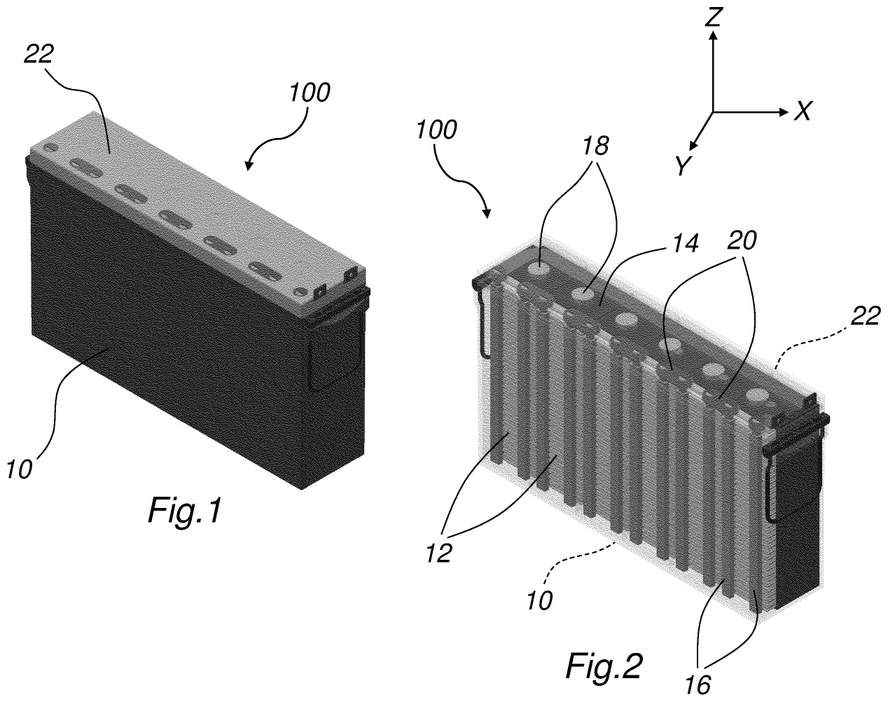

FIG. 1 shows an axonometric view of a lead acid battery object of the present invention;

FIG. 2 shows the axonometric view of the interior of the lead acid battery of FIG. 1;

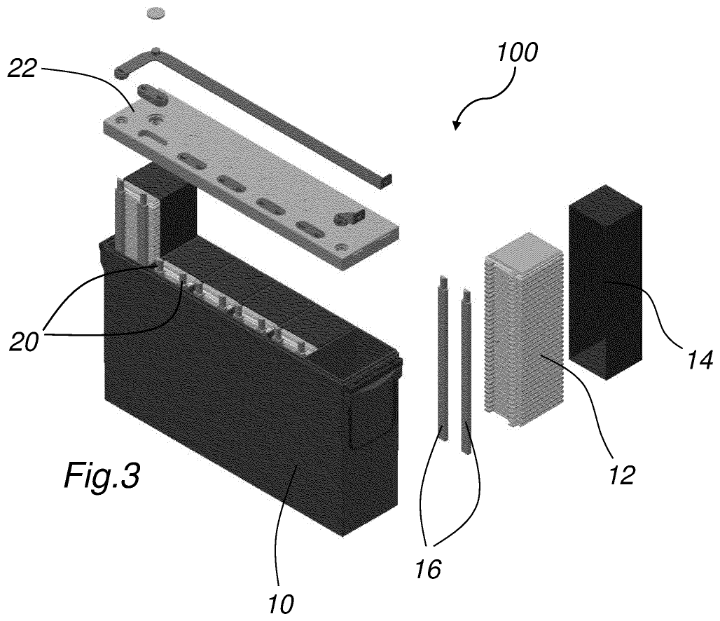

FIG. 3 shows the exploded view of the battery of FIG. 1;

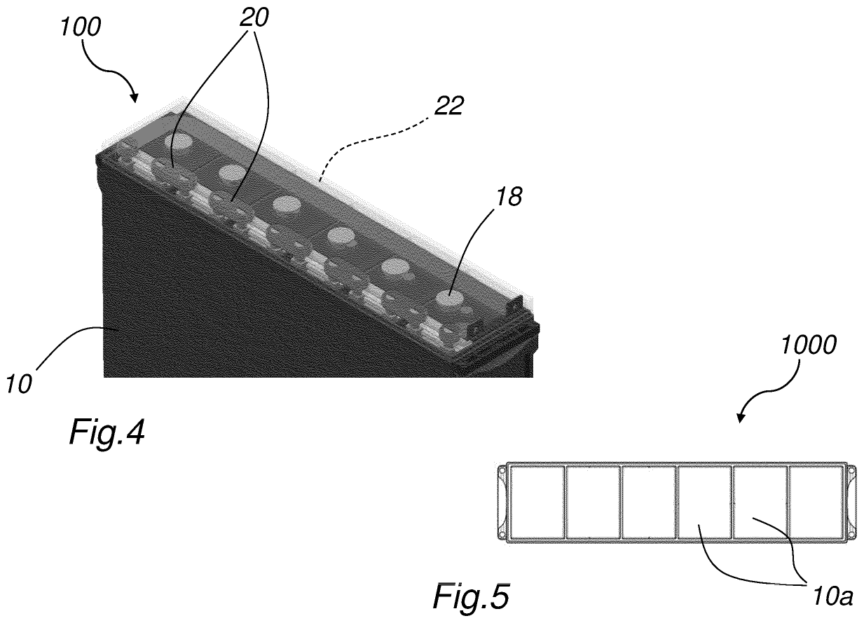

FIG. 4 shows the detail of the relief valves of the battery of FIG. 1;

FIG. 5 shows the internal layout of a range of types of the battery, and in particular
a type of 12 V battery with a capacity of 95 ampere-hours,
a type of 12 V battery with a capacity of 145 Ampere-hours,
a type of 12 V battery with a capacity of 175 Ampere-hours, object of the present invention.

The 12 V lead acid battery 100 with VRLA AGM technology and with front terminal connections, shown overall in FIGS. 1 to 5, object of the present invention, provides a monobloc consisting of
a container 10, with support base and retaining sides
plate groups 12
compression baskets 14 (object of patent application of the same Owner) of the plate groups 12
inter-plate connections or CoS 16
relief valves 18
inter-cell connections 20
a lid 22 closing the container 10.

The container 10, with support base and retaining sides, and the related lid 22 are of the known type (FHC battery range of Fiamm Energy Technology S.p.A.), made of plastic material, preferably PC/ABS (polycarbonate/acrylonitrile-butadiene-styrene), ABS (acrylonitrile-butadiene-styrene), PE (polyethylene) or PP (polypropylene), and thermo-welded together.

In particular, for convenience of description only and not being intended as a limitation, a reference tern is assumed, with directions respectively:
longitudinal X, corresponding to the length of battery 100, or long side;
transverse Y, corresponding to the width of battery 100, or short side;
perpendicular Z, corresponding to the height of battery 100.

Said container 10, with division of the internal volume according to the 6×1 (X×Y) configuration, provides side-by-side compartments 10a, equivalent in size and volume, arranged for housing the plate groups 12. Said compartments 10a, six in number, form inner sides parallel to each other and parallel to the short side (Y) of the battery 100.

The plate group 12 is conventionally understood as the set of positive and negative electrodes (plates) inside a cell, including the inter-electrode separator placed between each of them as a means of separation and diffusion of the electrolyte.

With regard to the battery 100 monobloc, the plates are arranged horizontally, i.e., parallel to lid 22, and stacked vertically, i.e., perpendicular to lid 22, and they connect in parallel with each other in variable number, according to the required capacity of the battery, in particular
battery 100 of the 12 V type with a capacity of 95 Ampere-hours (dimensions Y×X×Z: 126×558×226 mm);
battery 100 of the 12 V type with capacity of 145 Ampere-hours (dimensions Y×X×Z: 126×558×278 mm);
battery 100 of the 12 V type with capacity of 175 Ampere-hour (dimensions Y×X×Z: 126×558×316 mm).

Each plate group 12 is kept in compression by a corresponding basket 14 made of plastic material, chemically resistant to the electrolytic environment of the battery 100 and thermally resistant to the temperatures to which the battery 100 is subjected. Said basket 14 has a dual function inside the monobloc, of keeping the plate group 12 in an adequate and homogeneous state of compression while avoiding the usual mechanical deformations to which the container of a conventional battery is generally subjected, thus reducing the risk of bulging.

The CoS 16 (automatic lead-alloy fusion over the plates suitable for holding the same together to form the plate group) allow parallel connection between the plates inside a group 12 by welding together the plates arranged horizontally and stacked vertically, and they extend parallel to and along the long side (X) of the battery 100. A relief valve 18 is provided for each plate group 12, arranged to allow the release of gas in the event that the inner pressure exceeds the set safety value, so as to reduce the risks in the event of accidental obstruction of one of the valves.

The position of the relief valves 18 is parallel to the lid 22 of the container 10 and, consequently, parallel to the underlying plates of each group 12.

Inter-cell connections 20, which allow series connection between the plate groups 12 in order to produce the requested battery voltage, are located at the top of each plate group 12, at the upper end of each individual CoS 16.

Referring in particular to FIG. 5, the layout of the battery 100 object of the present invention brings significant advantages in electrical performance, design, and industrial processability to a range 1000 of types 12 V battery 100 consisting of
battery 100 of 95 Ampere-hour (Ah) capacity for standard 23″ racks and cabinets;
battery 100 of 145 Ampere-hour (Ah) capacity for standard 23″ racks and cabinets;
battery 100 of 175 Ampere-hour (Ah) capacity for standard 23″ racks and cabinets.

The horizontal arrangement of the plates—i.e., parallel to lid 22—stacked vertically—i.e., perpendicular to lid 22—allows the extension of CoS 16 parallel to and along the long side (X) of battery 100, thus allowing for greater use of its height (Z) in relation to container 10, said height may vary according to the number of plates required, to cover the range 1000 of types of battery 100 object of the invention.

The layout of the battery 100 object of the present invention, with the plates arranged horizontally and stacked vertically to form individual groups 12, as described above, reduces the stratification of the internal electrolyte, improving the expected life of the battery 100 especially when used cyclically at high depths of discharge.

The plate groups 12, kept in compression through the baskets 14, achieve higher values of compression due to the lack of friction between the plates and the retaining sides of the container 10 and maintain the initial compression for a longer time and more homogeneously.

In addition, during the assembly, basket 14, being made of plastic material, facilitates the insertion of plate group 12 inside the corresponding compartment 10a of container 10, improving the processability of battery 100.

Moreover, due to the lower pressure exerted by the plate groups 12, contained in the compression baskets 14, on the container 10 at the retaining sides, it is possible to reduce the thickness of the said retaining sides and, consequently, to reduce the production costs of the monobloc.

Though the invention has been described with reference to one possible embodiment, given for illustrative and non-limiting purposes, numerous modifications and variations will appear obvious to a person skilled in the art in the light of the above description. The present invention, therefore, is intended to cover all modifications and variations within the protective scope of the following claims.

1. A 12 V lead acid battery with VRLA AGM technology and having a monobloc, comprising:
a long side and a short side;
a plurality of internal compartments arranged in a 6×1 configuration;
front terminal connections;
a container including a support base and a plurality of retaining sides;
a plurality of plate groups in an interior of said container, each of said plate groups having a compression basket and a plurality of plates;
a plurality of inter-plate connections or CoS interconnecting said plurality of plates of said plate groups;
a plurality of relief valves respectively associated with said plurality of plate groups;
a plurality of inter-cell connections interconnecting said plurality of plate groups; and
a lid closing the container
wherein said monobloc has an internal layout configured to house said plate groups in a horizontal position, parallel to said lid.

2. The battery of claim 1, wherein the plates are arranged in a horizontal position and stacked vertically, perpendicular to said lid, and connected in parallel with each other in variable number, according to the required capacity of the battery, forming the groups which are kept in compression through the corresponding baskets.

3. The battery of claim 1, wherein the plates of the plate groups are welded together through the inter-plate connections or CoS, which extend parallel to and along the long side of the battery.

4. The battery of claim 1, wherein the container has six side-by-side internal compartments, equivalent in size and volume to one another, arranged for housing the compression baskets of the plate groups connected in parallel through the inter-plate connections or CoS, said compartments forming inner sides of the container parallel to each other and parallel to the short side of the battery.

5. The battery of claim 1, wherein the series connection between the plate groups is made through the inter-cell connections which are located at the top of each plate group, at the upper end of each individual inter-plate connection or CoS.

6. The battery of claim 1, wherein said relief valves are arranged parallel to said plates of each plate group.

7. The battery of claim 6, wherein said plurality of relief valves includes six relief valves arranged at the lid.

8. The battery of claim 1, wherein said container and said lid are made of a plastic material and are thermo-welded together.

9-10. (canceled)

11. The battery of claim 1, further comprising a set of positive and negative electrodes and interposed inter-electrode separators, wherein said compression basket
is made of a plastic material,
is chemically resistant to the electrolytic environment of a battery,
is thermally resistant to the temperatures to which a battery is subjected,
is configured to keep in compression the set of positive and negative electrodes and interposed inter-electrode separators, and
is configured to avoid mechanical deformation of said container.

12. The battery of claim 1, wherein said battery is configured for standard 23″ racks and cabinets and has a capacity in Ampere-hours (Ah) of 95, 145, or 175.
